(19) United States
(12) Patent Application Publication
(10) Pub. No.: US 2002/0042911 A1
(43) Pub. Date: Apr. 11, 2002

(54) Uninstall of an attached device

(76) Inventor: Jason J. Harms, Sioux City, IA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/682,775

(22) Filed: Oct. 18, 2001

Related U.S. Application Data
(60) Provisional application No. 60/293,894, filed on May 24, 2001.

(51) Int. Cl. G06F 9/445

(52) U.S. Cl. 717/173

(57) ABSTRACT

A method, apparatus, system, and signal-bearing medium for uninstalling software specific to a device that provides a clean uninstall. Entries in configuration data for a device with an unknown type are removed. The vendor of the device with the unknown type is determined, and subkeys in the configuration data for all devices associated with the vendor are searched. Keys in the configuration data associated with the vendor are deleted. Entries associated with the device in an initialization file are removed, and selected files associated with the device are deleted. In this way, all references to a device are removed, so as not to interfere with other applications or functions.

### CROSS REFERENCE TO RELATED APPLICATIONS

This application claims the benefit of U.S. Provisional Application No. 60/293,894, filed May 24, 2001.

### BACKGROUND OF INVENTION

The present invention relates to computers, and in particular to uninstalling a device attached to a computer.

### SUMMARY OF INVENTION

The invention provides a method, apparatus, system, and signal-bearing medium for uninstalling software specific to a device. Entries in configuration data for a device with an unknown type are removed. The vendor of the device with the unknown type is determined, and subkeys in the configuration data for all devices associated with the vendor are searched. Keys in the configuration data associated with the vendor are deleted. Entries associated with the device in an initialization file are removed, and selected files associated with the device are deleted. In this way, all references to a device are removed, so as not to interfere with other applications or functions.

In one particular embodiment, the invention is directed to software for uninstalling a previously installed device attached to a computer system where the previous installation was partial, incomplete, or otherwise was in error or which resulted in the operating system being unable to completely identify the attached device, or where the device is desired to be removed from the system so that a reinstallation of the device will occur without trouble or other undesired incident. The software insures that all files and artifacts that are not normally removed by the operating system are in fact removed or renamed so as not to interfere with other applications or functions, or not to interfere with a subsequent reinstallation of the device. In a particular embodiment, the software is capable of appropriating generic registry keys and renaming manufacturer-specific registry keys so that the computer system or operating system can properly detect the device at a later time such as during a subsequent installation of the device.

### BRIEF DESCRIPTION OF DRAWINGS

FIG. 1 is a block diagram of a computer system incorporating an uninstall function, according to an embodiment of the invention.

FIG. 2 is a flowchart of processing for a reinstall of an operating system, according to an embodiment of the invention.

FIG. 3 is a flowchart of processing for an uninstall function in a stand-alone utility, according to an embodiment of the invention.

FIG. 4 is a flowchart of processing for an uninstall function during reinstallation of an operating system, according to an embodiment of the invention.

### DETAILED DESCRIPTION

In the following detailed description of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

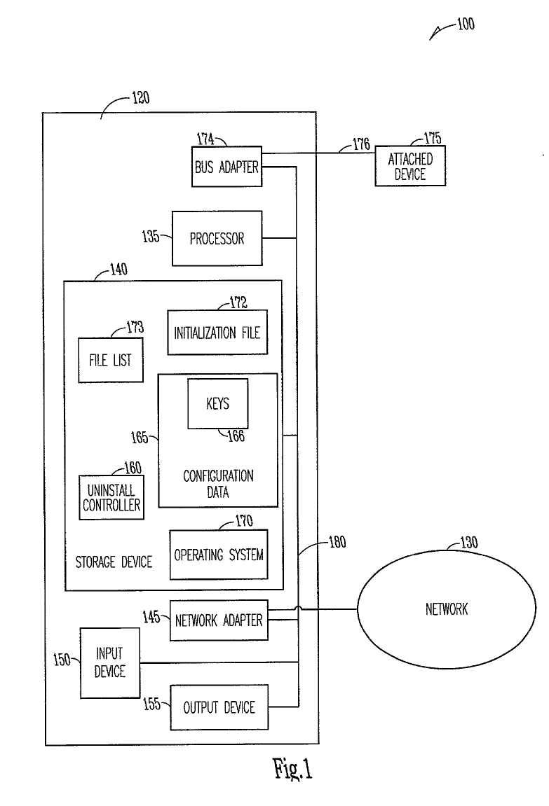

FIG. 1 depicts a block diagram of data processing system 100, according to an embodiment of the invention. Data processing system 100 includes computer 120 attached to network 130 and attached device 175. In another embodiment, network 130 is not present.

Computer 120 includes processor 135, storage device 140, network adapter 145, input device 150, output device 155, and bus adapter 174, all communicatively coupled via system bus 180.

Processor 135 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 135 executes instructions and includes that portion of computer 120 that controls the operation of the entire computer. Although not depicted in FIG. 1, processor 135 typically includes a control unit that organizes data and program storage in computer memory and transfers data and other information between the various parts of computer 120. Processor 135 may receive input data from input device 150 and network adapter 145, read and store code and data in storage device 140, and may present output data to a user via output device 155. Processor 135 also may transmit and receive packets of information across network 130 using network adapter 145.

Although computer 120 is shown to contain only a single processor and a single bus, the present invention applies equally to computers that may have multiple processors and to computers that may have multiple buses with some or all performing different functions in different ways.

Storage device 140 represents one or more mechanisms for storing data. For example, storage device 140 may include read only memory (ROM), random access memory (RAM), magnetic disk storage media, optical storage mediums, flash memory devices, and/or other machine-readable media. Although only one storage device 140 is shown, multiple storage devices and multiple types of storage devices may be present. Further, although computer 120 is drawn to contain storage device 140, in other embodiments storage device 140 may be distributed across other computers attached via a network, such as network 130.

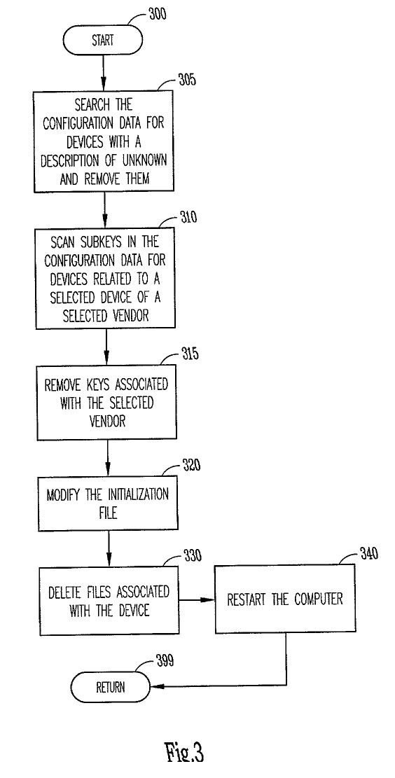

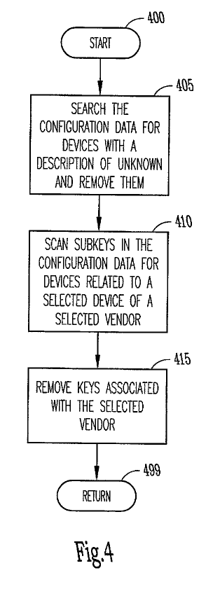

Storage device 140 contains uninstall controller 160, configuration data 165, operating system 170, initialization file 172, and file list 173. Uninstall controller 160 may include instructions capable of being executed on processor 135 to carry out the functions of the present invention, as further described below with reference to FIGS. 3 and 4. In another embodiment, some or all of the functions of the present invention may be carried out via hardware in lieu of a processor-based system. Of course, storage device 140 may also contain additional software and data (not shown), which is not necessary to understanding the invention.

In an embodiment, operating system 170 may be the Microsoft Windows operating system. But in other embodiments, operating system 170 may be the Linux, Unix, Macintosh, or any other appropriate operating system.

Configuration data 165 stores information necessary to configure computer system 100. In one embodiment, configuration data 165 may be a hierarchical database, but in other embodiments configuration data 165 may be any type of data repository. Although configuration data 165 is shown as being a single unit, in other embodiments, configuration data 165 is composed of multiple pieces of data in multiple locations. Configuration data 165 contains information that operating system 170 references during operation. In an embodiment, configuration data 165 may be the registry of the Windows operating system. The Windows registry replaces the files “autoexec.bat” and “config.sys” in DOS (Disk Operating System). But, in other embodiments, configuration data 165 may be any appropriate configuration data. Configuration data 165 contains keys 166. Keys 166 may contain settings information for values in configuration data 165. Keys 166 are further described below with reference to FIG. 3.

Initialization file 172 contains data that is processed by operating system 170 when the computer boots up. In an embodiment, initialization file 172 may be the Windows “Win.ini file,” but in other embodiments, initialization file 172 may be any appropriate initialization file. File list 173 contains a list of files to be deleted and is further described below with respect to FIG. 3.

Referring again to FIG. 1, system bus 180 represents one or more busses (e.g., PCI, ISA (Industry Standard Architecture), X-Bus, EISA (Extended Industry Standard Architecture), or any other appropriate bus) and bridges (also termed bus controllers).

Input device 150 is that part of computer 120 that accepts input from a user. In an embodiment, input device 150 may be a keyboard, but in other embodiments, input device 150 may be a pointing device, mouse, trackball, keypad, touchpad, touch screen, pointing stick, microphone, or any other appropriate input device. Although only one input device 150 is shown, in other embodiments any number of input devices of the same or of a variety of types may be present.

Output device 155 communicates information to the user of computer 120. Output device 155 may be a cathode-ray tube (CRT) based video display well known in the art of computer hardware. But, in other embodiments output device 155 may be replaced with a liquid crystal display (LCD) based or gas, plasma-based, flat-panel display. In still other embodiments, any appropriate display device is used. In yet embodiments, a speaker that produces audio output may be used. Although only one output device 155 is shown, in other embodiments, any number of output devices of different types or of the same type may be present. In other embodiments, output device 155 might not be present.

Network adapter 145 facilitates communication between computer 120 and network 130. Network adapter 145 provides a user of computer 120 with a means of electronically communicating information, such as code and data, with an unillustrated computer or computers attached to network 130. In addition, in another embodiment, network adapter 145 may support distributed processing, which enables computer 120 to share a task with other devices linked to network 130. Although network adapter 145 is shown as part of computer 120, in another embodiment they may be packaged separately. Although only one network adapter 145 is shown, in other embodiments, multiple network adapters of the same or of a variety of types may be present.

Bus adapter 174 sends and receives data and commands between system bus 180 and device bus 176. In an embodiment, device bus 176 may be a USB (Universal Serial Bus). In other embodiments, device bus 176 may be a IEEE 1394 bus, a wireless interface such as IEEE 802.11, or BlueTooth. In still other embodiments any appropriate serial, parallel, or other type of bus may be used.

In an embodiment, attached device 175, which is attached to computer 120 via device bus 176, may be a printer. But, in other embodiments attached device may be a storage device, hard disk, floppy disk, semiconductor memory device, CD drive, DVD drive, device reader, keyboard, display device, modem, scanner, network adapter, mouse, touchpad, joystick, foot pedal, camera, pointing device, microphone, or any other kind of memory, storage, input device, or output device capable of being attached and installed to computer 120 and subsequently uninstalled. Although attached device 175 is shown as being external to computer 120, in other embodiments attached device 175 may be attached internally to computer 120. In still other embodiments, attached device 175 may be attached indirectly to computer 120 via a network, such as network 130.

Computer 120 may be implemented using any suitable hardware and/or software, such as a personal computer available from a number of vendors. Portable computers, laptop or notebook computers, mainframe computers, handheld devices, PDAs (Personal Digital Assistants), and network computers or Internet appliances are examples of other possible configurations. The hardware and software depicted in FIG. 1 may vary for specific applications and may include more or fewer elements than those depicted. For example, other peripheral devices such as audio adapters, or chip programming devices, such as EPROM (Erasable Programmable Read-Only Memory) programming devices may be used in addition to or in place of the hardware already depicted. Thus, an embodiment of the invention may apply to any hardware configuration that supports the installation and uninstallation of attached devices.

Network 130 may be any suitable network. Although only one network 130 is shown, in other embodiments any number of networks may be present. In an embodiment, network 130 may support wireless communications. In another embodiment, network 130 may support hard-wired communications, such as a telephone line or cable. Network 130 may support any appropriate protocol. In an embodiment networks 130 is the Internet and supports TCP/IP (Transmission Control Protocol/Internet Protocol). In other embodiments, network 130 may be a local area network (LAN) or a wide area network (WAN).

As will be described in detail below, aspects of an embodiment pertain to specific apparatus and method elements implementable on computers. In another embodiment, the invention may be implemented as a program product for use with a computer. The programs defining the functions of this embodiment may be delivered to a computer via a variety of signal-bearing media, which include, but are not limited to:

(1) information permanently stored on non-rewriteable storage media (e.g., read only memory devices within a computer such as CD-ROM readable by an unillustrated CD-ROM drive;

(2) alterable information stored on rewriteable storage media (e.g., a hard disk drive or diskette); or

(3) information conveyed to a computer by a communications medium, such as through a computer or telephone network accessed via network adapter 145, including wireless communications.

Such signal-bearing media, when carrying processor-readable instructions that direct the functions of the present invention, represent embodiments of the present invention.

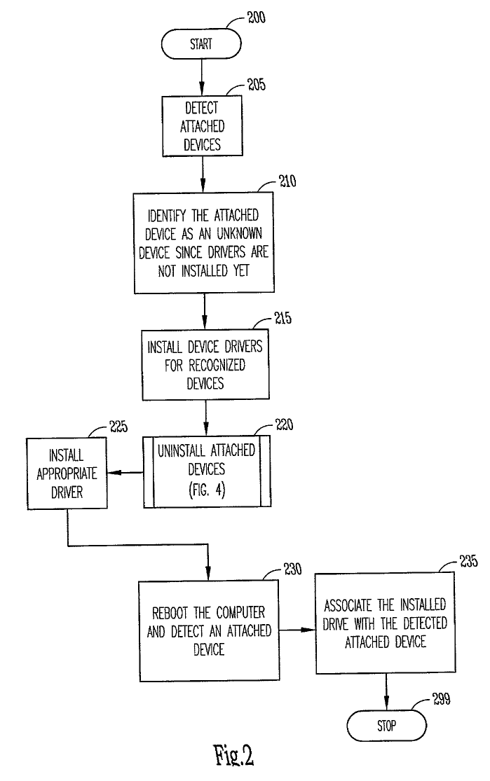

FIG. 2 is a flowchart of processing for a reinstall of an operating system on a computer, according to an embodiment of the invention. Although FIG. 2 will be described using Microsoft Windows terminology, the functions of FIG. 2 apply equally to any appropriate operating system. Control begins a block 200. Control then continues to block 205 where during a reinstall of the Microsoft Windows operating system, one of the last actions of the Windows Setup function is to detect an attached device if it is plugged in. Windows attempts to determine what type of a device is attached to a port and whether or not there are drivers available to install for this device.

Control then continues to block 210 where Windows identifies the attached device as an “Unknown Device” because the drivers for the attached device are not yet installed. Thus, attached device 175 may be identified by system 100 as an “unknown device” or “unknown type.” “Unknown” as defined herein means that the device is not identified or is only partially identified by operating system 170. One particular definition of “unknown” as set forth herein means that the drivers for the device have not been installed, have been incompletely installed, or are not the better drivers compared with other alternative drivers available to be installed. For example, an unknown device may include a device on a system that has generic drivers installed, but does not have manufacturer-specific drivers installed, or does not have later versions of the drivers installed. As defined herein, an attached device may be specified as an “unknown device” or of an “unknown type” by operating system 170 while simultaneously being known and identified by a user, the manufacturer, another operating system, etc. A device with an unknown type is an unknown device.

Control then continues to block 215 where Windows completes its installation and installs applications and device drivers for recognized devices. Control then continues to block 220 where the functions of uninstall controller 160 are invoked, as further described below with reference to FIG. 4. Referring again to FIG. 2, control then continues to block 225 where the appropriate driver is installed from an installation medium, such as a CD.

Control then continues to block 230 where the computer is rebooted, and Windows redetects the attached device. Control then continues to block 235 where Windows associates the installed device driver, which is now present, with the detected attached device. Control then continues to block 299 where the process ends.

The flowchart of FIG. 3 describes the processing for functions of uninstall controller 160 in a stand-alone utility, which searches through configuration data 165 (the Windows registry in one embodiment) in the area dealing with the attached devices of computer 120 and detects whether or not an attached device, such as attached device 175, has been installed. Uninstall controller 160 then eliminates files and registry entries related to that attached device. After this process is completed, the attached device may be installed either from the device vendor's installation medium or from the drivers on the operating system's installation medium (The Windows Restoration CD in an embodiment).

Control begins at block 300. Control then continues to block 305 where uninstall controller 160 searches configuration data 165 for any devices that have a description of “Unknown” and removes them regardless of what type of device it really is. In a Windows embodiment, uninstall controller searches HKEY_LOCAL_MACHINE\Enum\USB.

Control then continues to block 310 where uninstall controller 160 rescans subkeys within keys 166 for any data related to an attached device. In a Windows embodiment, uninstall controller 160 scans the HKEY_LOCAL_MACHINE\Enum\USB registry subkey for any data related to an attached device. The Windows registry file is organized in a hierarchical fashion, and a subkey is a key within a key, analogous to a subdirectory within a directory. The device vendors identify their devices in different ways, so uninstall controller 160 detects which vendor has its attached device installed and only uninstalls that attached device vendor's drivers. This saves time and allows for more than one attached device of the same vendor to be removed.

Once an attached device has been found under the HKEY_LOCAL_MACHINE\Enum\USB subkey (in a Windows embodiment) and the vendor has been determined, control continues to block 315 where uninstall controller 160 removes the appropriate registry keys. Below is attached a list of common registry keys that are searched and removed in a Windows embodiment if there are attached device references in them. The below registry keys are examples for a USB printer device, but any type of device and bus may be used in other embodiments.

HKEY_LOCAL_MACHINE\enum\usb\

HKEY_LOCAL_MACHINE\System\CurrentControlSet\Control\Print\Environments\Windows
4.0\Drivers

HKEY_LOCAL_MACHINE\System\currentcontrolset\control\print\monitors
HKEY_LOCAL_MACHINE\System\CurrentControlSet\Control\Print\Ports
HKEY_LOCAL_MACHINE\System\CurrentControlSet\Control\Print\Printers
HKEY_LOCAL_MACHINE\Config\0001

\System\CurrentControlSet\Control\Print\Printers

HKEY_LOCAL_MACHINE\System\CurrentControlSet\Services\Class
More generically, for any attached device 175, any one or more of the following

registry keys are searched and removed:

HKEY_LOCAL_MACHINE\enum\device bus\
HKEY_LOCAL_MACHINE\System\CurrentControlSet\Control\device

function\Environments\Windows 4.0\Drivers

HKEY_LOCAL_MACHINE\System\currentcontrolset\control\device function\monitors
HKEY_LOCAL_MACHINE\System\CurrentControlSet\Control\device function\Ports
HKEY_LOCAL_MACHINE\System\CurrentControlSet\Control\device function\device

type

HKEY_LOCAL_MACHINE\Config\0001\System\CurrentControlSet\Control\device

function\device type

HKEY_LOCAL_MACHINE\System\CurrentControlSet\Services\Class, where device bus

indicates a type of bus the predetermined device uses to couple to the computer system
(e.g., USB), device function indicates a function the predetermined devices provides (e.g.,
print), and device type indicates a group classification of the predetermined device (e.g.,
printer).

Control then continues to block 320 where uninstall controller 160 modifies initialization file 172. In a Windows embodiment, initialization file 172 may be the “Win.ini” file, and uninstall controller 160 may clear the “load=”, “run=”, “device=“lines, and the “devices” and “printerports” sections. This will help operating system 170 from assuming that attached devices are installed. Generically, “printerports” can be described herein as “deviceports” where device refers to the type of the device.

Control then continues to block 330 where uninstall controller 160 deletes files related to the attached device. In the windows embodiment, the files may be in “windows/inf,” “windows/system,” and “windows\system32.” Uninstall controller 160 retrieves a list of files to search for from file list 173. When these files are found, a copy is made of these files adding a ”.bkp” extension to the end. Windows will not know what file it actually is, but technicians using uninstall controller 160 may get these files back. In a windows embodiment, uninstall controller 160 adds the original file to the “windows\wininit.ini” file. Windows will either rename or delete the files listed in this file depending on the entry. Uninstall utility 160 informs Windows to delete the files because there was already a back up made earlier.

Control then continues to block 340 where uninstall controller 160 restarts computer 120 in order for the “windows\wininit.ini” file to be processed, in a Windows embodiment. Computer 120 is now in a similar state as the point before attached device 175 was plugged in, and attached device 175 may now be reinstalled.

Control then continues to block 399 where the function returns.

FIG. 4 is a flowchart of processing for an uninstall function during reinstallation of an operating system, according to an embodiment of the invention.

Control begins at block 400. Control then continues to block 405 where uninstall controller 160 searches configuration data 165 for any devices that have a description of “Unknown” and removes them regardless of what type of device it really is. In a Windows embodiment, uninstall controller searches HKEY_LOCAL_MACHINE\Enum\USB.

Control then continues to block 410 where uninstall controller 160 rescans subkeys within keys 166 for any data related to an attached device. In a Windows embodiment, uninstall controller 160 scans the HKEY_LOCAL_MACHINE\Enum\USB registry subkey for any data related to an attached device. The Windows registry file is organized in a hierarchical fashion, and a subkey is a key within a key, analogous to a subdirectory within a directory. The device vendors identify their devices in different ways, so uninstall controller 160 detects which vendor has its attached device installed and only uninstalls that attached device vendor's drivers. This saves time and allows for more than one attached device of the same vendor to be removed.

Once an attached device has been found under the HKEY_LOCAL_MACHINE\Enum\USB subkey (in a Windows embodiment) and the vendor has been determined, control continues to block 415 where uninstall controller 160 removes the appropriate registry keys. Below is attached a list of common registry keys that are searched and removed in a Windows embodiment if there are attached device references in them. The below registry keys are examples for a USB printer device, but any type of device and bus may be used in other embodiments.

HKEY_LOCAL_MACHINE\enum\usb\

HKEY_LOCAL_MACHINE\System\CurrentControlSet\Control\Print\Environments\Windows
4.0\Drivers
HKEY_LOCAL_MACHINE\System\currentcontrolset\control\print\monitors

HKEY_LOCAL_MACHINE\System\CurrentControlSet\Control\Print\Ports
HKEY_LOCAL_MACHINE\System\CurrentControlSet\Control\Print\Printers
HKEY_LOCAL_MACHINE\Config\0001

\System\CurrentControlSet\Control\Print\Printers

HKEY_LOCAL_MACHINE\System\CurrentControlSet\Services\Class
More generically, for any attached device 175, any one or more of the following

registry keys are searched and removed:

HKEY_LOCAL_MACHINE\enum\device bus\
HKEY_LOCAL_MACHINE\System\CurrentControlSet\Control\device

function\Environments\Windows 4.0\Drivers

HKEY_LOCAL_MACHINE\System\currentcontrolset\control\device function\monitors
HKEY_LOCAL_MACHINE\System\CurrentControlSet\Control\device function\Ports
HKEY_LOCAL_MACHINE\System\CurrentControlSet\Control\device function\device

type

HKEY_LOCAL_MACHINE\Config\0001\System\CurrentControlSet\Control\device

function\device type

HKEY_LOCAL_MACHINE\System\CurrentControlSet\Services\Class, where device bus

indicates a type of bus the predetermined device uses to couple to the computer system
(e.g., USB), device function indicates a function the predetermined devices provides (e.g.,
print), and device type indicates a group classification of the predetermined device (e.g.,
printer).

Control then continues to block 499 where the function returns.

The invention described herein removes all traces of an attached device 175 that has been installed on system 100. For example, where attached device 175 is a USB printer, and bus adapter 174 and device bus 176 are a USB bus adapter and USB device bus, respectively, the registry of system 100 and other places in system 100 are searched for files and entries related to USB printers are removed, so that all traces of the USB printer are removed from system 100. For example, the invention searches the registry to determine what kinds of attached device 175 have been installed or have been attempted to be installed. Registry entries for a predetermined one of attached device 175 are removed, and also any Win.ini files associated with the predetermined attached device 175. As a result, system 100 will contain no traces of the previous installation of the USB printer so that system is “clean”, meaning that no files or other remnants of that particular USB device remain in system 100. In the event of a future reinstallation of the particular device, such as during a system restoration, attached device 175 will be correctly identified and the proper drivers will be correctly loaded.

Although the invention has been described with a certain degree of particularity, it should be recognized that elements thereof may be altered by persons skilled in the art without departing from the spirit and scope of the invention and without providing a substantial change thereto. One of the embodiments of the invention can be implemented as sets of instructions resident in the memory of one or more computer systems configured generally as described in FIG. 1. Until required by the computer system, the set of instructions may be stored in another computer readable memory such as an auxiliary memory, for example in a hard disk drive or in a removable memory such as an optical disk for utilization in a CD-ROM drive, a floppy disk for utilization in a floppy disk drive, a combination floppy and optical disk for utilization in a floppy-optical drive, or a personal computer memory card for utilization in a personal computer card slot. Further, the set of instructions can be stored in the memory of another computer and transmitted over a local area network or a wide area network, such as the Internet, when desired by the user. Additionally, the instructions may be transmitted over a network in the form of an applet or a servlet that is interpreted or compiled after transmission to the computer system rather than prior to transmission. One skilled in the art would appreciate that the physical storage of the sets of instructions or applets physically changes the medium upon which it is stored electrically, magnetically, chemically, physically, optically or holographically so that the medium carries computer readable information.

1. A method, comprising:
searching configuration data for an entry for a device with an unknown type; and
removing the entry for the device with the unknown type from the configuration data.

2. The method of claim 1, further comprising:
determining a vendor of the device with the unknown type;
searching subkeys in the configuration data for all devices associated with the vendor; and
deleting keys associated with the devices associated with the vendor.

3. The method of claim 1, further comprising:
modifying an initialization file to remove device information.

4. The method of claim 1, further comprising:
deleting files identified in a file list.

5. The method of claim 4, wherein the deleting element further comprises:
saving a backup copy of the files prior to deletion.

6. A method, comprising:
searching a registry for a USB (Universal Serial Bus) printer with an unknown description; and
removing an entry for the printer with the unknown description from the registry.

7. The method of claim 6, further comprising:
determining a vendor of the printer;
searching subkeys in the registry for all printers associated with the vendor; and
deleting keys for all the printers associated with the vendor.

8. The method of claim 6, further comprising:
clearing load, run, and device lines from an initialization file.

9. The method of claim 6, further comprising:
removing a devices section and a printerports sections from an initialization file.

10. A signal-bearing medium comprising instructions, wherein the instructions when executed comprise:
deleting entries in a configuration file for all devices with an unknown description;
scanning subkeys in the configuration file for a device entry associated with a selected vendor; and
removing keys from the configuration file, wherein the keys are associated with the device entry.

11. The signal-bearing medium of claim 10, wherein the instructions further comprise:
removing references associated with the device from an initialization file.

12. The signal-bearing medium of claim 10, wherein the instructions further comprise:
deleting files identified in a file list.

13. A computer, comprising:
a processor; and
storage comprising instructions executable on the processor, wherein the instructions when executed comprise:
detecting devices attached to the computer, identifying the attached devices as unknown when drivers for the attached devices are not present,
installing device drivers, and
deleting entries in a configuration file for all devices with an unknown description.

14. The computer of claim 13, wherein the instructions further comprise:
scanning subkeys in the configuration file for a device entry associated with a selected vendor.

15. The computer of claim 14, wherein the instructions further comprise:
removing keys from the configuration file, wherein the keys are associated with the device entry.

16. The computer of claim 13, wherein the instructions further comprise:
modifying an initialization file to remove information associated with the device.

17. An apparatus, comprising:
means for removing a registry key associated with a predetermined device of a computer system; and
means for modifying a configuration file to indicate removal of the predetermined device from the computer system,
wherein the predetermined device is removed from the computer system so as to not interfere with a subsequent device installation.

18. An apparatus as claimed in claim 17, wherein said removing means includes means for removing registry keys according to a vendor of the predetermined device.

19. An apparatus as claimed in claim 17, said removing means removing at least one registry key selected from a list of registry keys consisting of:
HKEY_LOCAL_MACHINE\enum\device bus\
HKEY_LOCAL_MACHINE\System\CurrentControlSet\Control\device
function\Environments\Windows 4.0\Drivers
HKEY__LOCAL_MACHINE\System\currentcontrolset\control\device
function\monitors
HKEY_LOCAL_MACHINE\System\CurrentControlSet\Control\device function\Ports
HKEY_LOCAL_MACHINE\System\CurrentControlSet\Control\device function\device
type
HKEY_LOCAL_MACHINE\Config\0001\System\CurrentControlSet\Control\device
function\device type
HKEY_LOCAL_MACHINE\System\CurrentControlSet\Services\Class,
where device bus indicates a type of bus the predetermined device uses to couple to the computer system, device function indicates a function the predetermined devices provides, and device type indicates a group classification of the predetermined device.

20. An apparatus as claimed in claim 17, said modifying means modifying the configuration file, wherein the configuration file is selected from a list consisting of: win.ini, windows.inf, windows\system, and windows\system32.

21. An apparatus as claimed in claim 17, said removing means removing at least one registry key, wherein the at least one register key is selected from a list of registry keys consisting of:
HKEY_LOCAL_MACHINE\enum\device bus\
HKEY_LOCAL_MACHINE\System\CurrentControlSet\Control\device
function\Environments\Windows 4.0\Drivers
HKEY_LOCAL_MACHINE\System\currentcontrolset\control\device
function\monitors
HKEY_LOCAL_MACHINE\System\CurrentControlSet\Control\device function\Ports
HKEY_LOCAL_MACHINE\System\CurrentControlSet\Control\device function\device
type
HKEY_LOCAL_MACHINE\Config\0001\System\CurrentControlSet\Control\device
function\device type
HKEY__LOCAL_MACHINE\System\CurrentControlSet\Services\Class,
where the device bus indicates a type of bus the predetermined device uses to
couple to the computer system, the device function indicates a function the
predetermined devices provides, and the device type indicates a group
classification of the predetermined device, and the modifying means modifying at
least one of the following configuration files: win.ini, windows.inf,
windows\system, and windows\system32.

22. An apparatus as claimed in claim 17, the modifying means modifying a win.ini file by clearing at least one or more of following lines in the win.ini file associated with the predetermined device: load=, run=, device=lines, and at least one or more of the following sections of the win.ini file: devices and deviceports sections.

23. An apparatus as claimed in claim 17, said removing means being configured by one or more of the following: software stored on an information storage medium and loaded onto the computer system, software downloaded onto the computer system via a network, and software instructions executed by a remote machine coupled to the computer system via a network.

24. An apparatus as claimed in claim 17, said modifying means being configured by one or more of the following: software stored on an information storage medium and loaded onto the computer system, software downloaded onto the computer system via a network, and software instructions executed by a remote machine coupled to the computer system via a network

25. An apparatus as claimed in claim 21, the removing means being configured by one or more of the following: software stored on an information storage medium and loaded onto the computer system, software downloaded onto the computer system via a network, and software instructions executed by a remote machine coupled to the computer system via a network.

26. An apparatus as claimed in claim 21, said modifying means being configured by one or more of the following: software stored on an information storage medium and loaded onto the computer system, software downloaded onto the computer system via a network, and software instructions executed by a remote machine coupled to the computer system via a network
